(19) United States
(12) Patent Application Publication
(10) Pub. No.: US 2007/0002996 A1
(43) Pub. Date: Jan. 4, 2007

(54) Tabletop nuclear fusion generator

(76) Inventor: Richard Neifeld, Arlington, VA (US)

Correspondence Address: NEIFELD IP LAW, P.C., 4813-B Eisenhower Avenue, Alexandria, VA, 22304, US

(21) Appl. No.: 11/170,768

(22) Filed: Jun. 30, 2005

Related U.S. Application Data
(60) Provisional application No. 60/583,788, filed on Jun. 30, 2004.

(51) Int. Cl. H05H 1/22

(52) U.S. Cl. 376/100

(57) ABSTRACT

The invention provides systems and methods for generating nuclear fusion by generating and collapsing bubbles, comprising using a conduit for enclosing a liquid; a source of pressure to force said liquid to flow in said conduit; a bubble generator designed to generate bubbles in said conduit; and at least one of a pulsed laser positioned so that pulses of said pulsed laser impinge liquid in said conduit and a variation in cross-section of said conduit designed to induce rapid pressure changes in liquid flowing in said conduit; wherein said system is designed such that operation results in flow of liquid in the conduit and nuclear fusion of nuclei of atoms in said liquid.

### FIELD OF THE INVENTION

This invention related to nuclear fusion.

### BACKGROUND OF THE INVENTION

Bubble generators are old and well known in the art. See for example:
PAT. NO. Title
1 U.S. Pat. No. 6,655,664 Adjustable bubble generator practical for use as a relief valve
2 U.S. Pat. No. 6,523,945 Bubble generator for an ink jet print cartridge
3 U.S. Pat. No. 6,482,096 Swing ride with bubble generator
4 U.S. Pat. No. 6,382,601 Swirling fine-bubble generator
5 U.S. Pat. No. D445,046 Bubble generator
6 U.S. Pat. No. 6,170,303 Washing machine equipped with an air bubble generator having contraction/enlargement exhaust nozzles
7 U.S. Pat. No. 6,139,137 Bottom fill inkjet cartridge through bubble generator
8 U.S. Pat. No. 6,094,948 Washing machine with an air bubble generator
9 U.S. Pat. No. 6,062,935 Bubble generator
10 U.S. Pat. No. 6,035,553 Footwear with integral bubble generator
11 U.S. Pat. No. 5,933,175 Bottom fill inkjet cartridge through bubble generator
12 U.S. Pat. No. 5,770,118 Bubble generator for a washing machine
13 U.S. Pat. No. 5,765,997 Bubble generator for a washing machine
14 U.S. Pat. No. 5,653,129 Washing machine with a bubble generator
15 U.S. Pat. No. 5,307,649 Washing machine with a bubble generator
16 U.S. Pat. No. 5,295,373 Washing machine with a bubble generator
17 U.S. Pat. No. 5,266,240 Flotation reactor with external bubble generator
18 U.S. Pat. No. 5,253,380 Washing machine with a bubble generator and method of laundering with use of air bubbles
19 U.S. Pat. No. 5,234,112 Flotation reactor with external bubble generator
20 U.S. Pat. No. 5,110,512 Adjustable bubble generator
21 U.S. Pat. No. 5,014,239 Magnetic bubble generator using plural conductors with common current source
22 U.S. Pat. No. 4,961,882 Fine bubble generator and method
23 U.S. Pat. No. D311,250 Bubble generator for a bathtub
24 U.S. Pat. No. 4,932,786 Bubble generator for cellular concrete
25 U.S. Pat. No. 4,855,088 Bubble generator and method
26 U.S. Pat. No. 4,762,004 Gas flowmeter and soap bubble generator
27 U.S. Pat. No. 4,752,383 Bubble generator
28 U.S. Pat. No. 4,720,814 Magnetic bubble generator for bubble memory in hybrid technology
29 U.S. Pat. No. 4,463,447 Magnetic bubble generator
30 U.S. Pat. No. 4,388,700 Nucleation bubble generator for bubble domain devices
31 U.S. Pat. No. 4,276,713 Percolating bubble generator
32 U.S. Pat. No. 4,273,801 Passive bubble generator
33 U.S. Pat. No. 4,269,797 Bubble generator
34 U.S. Pat. No. 4,062,143 Bubble generator

In addition, bubbles may be seeded by collision of neutrons with nuclei of atoms in the solution.

Research by LLNL personnel recently determined that single bubble sonnoluminescence (SBSL) includes a light pulse duration of equal to or less than 12 picoseconds that occurs in an area smaller than 3 microns in diameter, in addition to a longer more diffuse light pulse originating from a diameter on the order of 10 microns. Light is synced generally synced to the minimum size of the bubble. Research by a group at Rensaller Polytechnic announced in April 2004 that they had confirmed D, D fusion in SBSL, possible via generation of smaller than normal seed bubbles. However, the rate per volume of fusion is so low that it is not feasible to consider SBSL as a potential source of energy. That is, the SBSL fusion rate is far below the breakeven point for exceeding energy used to generate the fusion.

Papers on the subject describe the temperature per particle required for thermonuclear fusion at a non negligible rate on the order of an MEV (millions of electron volts) per nuclei.

Theorists do not agree on the process generating high temperatures in SBSL.

### SUMMARY OF THE INVENTION

The invention provides a system and method for bubble induced nuclear fusion.

Methodology

Instead of attempting to model SBSL, I work back words from what necessarily has to happen to fit the facts noted above, and then extrapolate how to increase the average spatial and temporal nuclear fusion rate.

D or H nuclei must have kinetic energy on the order of a MEV to overcome nuclear repulsion so that they can fuse at non negligible rate. SBSL bubbles are less than a mm in size at their maximal size. SBSL bubbles expand and contract at the driving standing wave pressure frequency. In the work noted above the frequency is on the order of 30,000 hertz. SBSL in the work noted above appears to have required a liquid container with spherical symmetry or at least cylindrical symmetry. It is known that the SBSL occurs at a standing wave maxima; where pressure variations are maximized.

Contraction of a bubble contracting from less than a mm in diameter to a substantially zero diameter by imploding, provides an speed of bubble wall implosion of about ½ the period of oscillation ( 1/60,000 seconds) from 1 mm to zero. That is an average speed of 0.5/60,000 or 8 times ten to the sixth mm/second; about 10 to the fifth mm/sec, which is about 1000 meters per second. Nuclei in the bubble, to reach the MEV energy levels required for D-D fusion, would need to elastically bounce off contracting bubble walls a very large number of times to achieve that energy. It is highly unlikely that any nuclei elastically collide with imploding atoms imploding at the acoustically pressure wave speed and bounce back toward the center a sufficient number of times to reach MEV energies. That is, it is unrealistic to expect that MEV energies are achieved via kinetic processes involving collisions based upon the average speed of bubble collapse generated solely by acoustically generated pressure wave induced variations in bubble diameter.

However, nuclei in the bubble eventually do reach MEV energy levels as indicated by the existence of the D-D fusion reaction. Therefore, nuclei that remains in the bubble until “the bubble” is maximally compressed must undergo either a large number of collisions in which it gains a relatively small amount of energy in each collision (very unlikely), or a few collisions in which it gains a lot of energy (much more likely), or a mixture thereof.

Collisions of nuclei that remain in the bubble until achieving MEV energy levels necessarily occur either with other atoms/nuclei in the bubble or with atoms/nuclei outside the bubble but near the surface of the bubble and in which collisions the nuclei is scattered substantially backward and substantially elastically back into “the bubble.” This is because collisions in which the nuclei does not scatter back into the bubble result in that nuclei not being in the bubble when it is maximally compressed. For collisions further from the bubble, even if the nuclei scatters back toward the bubble, generally, the nuclei would suffer energy loss prior to reentering the bubble due to additional collisions. Collisions that are not elastic result in kinetic energy transfer from the nuclei into surrounding media and excitations including emission of photons.

In order for the nuclei in the bubble region to reach MEV kinetic energies, the contraction of the matter in the bubble region must not be substantially slowed down by the outward pressure from matter and nuclei in the bubble, at least not until the nuclei in the bubble reach the observed MEV kinetic energy. This condition is favored if the pressure in the bubble remains very low. That is, the density in the bubble must remain low enough such that matter in the region of the bubble is continued to be compressed until after substantial numbers of nuclei in the bubble region reach MEV kinetic energies. Moreover, as the bubble decreases in size the density must remain low, which suggests that “the bubble” loses matter during an implosion.

The foregoing conclusions lead to the following analysis.

First, reaching MEV kinetic energies is a transient non-equilibrium phenomena, linked to the duration of the bubble collapse. Specifically, a slow bubble collapse would allow thermalization of kinetic energy, precluding relatively high temperatures. Accordingly, the faster the bubble collapse, the higher the resulting bubble nuclei temperature. This suggests that, somehow, the implosion of matter in the region of the bubble is faster, much faster, than the average velocity of the wall of the bubble derived from the acoustic frequency period would indicate.

Second, the faster the bubble collapse, the less of a number of collisions required by a nuclei remaining in “the bubble” with imploding nuclei in the wall of the bubble are required to achieve an MEV kinetic energy in that nuclei remaining in “the bubble”. This is because the higher the speed of the imploding wall of the bubble, the more energy imparted to a nuclei bouncing off an atom or nuclei in that imploding wall. Third, the faster the bubble collapse, the larger the number of nuclei in “the bubble” that avoid thermalization loss of energy to transmitted to media away from the bubble.

Increasing the Bubble Collapse Speed

Bubble collapse speed is apparently initially controlled by SBSL pressure wave, since the SL bubble's size is periodic with the pressure frequency. SBSL pressure wave frequency has generally been a cavity resonance frequency defined by the geometry and size of the container of the liquid. Accordingly, one mechanism to increase the density of MEV kinetic energy nuclei is to up the resonance frequency to thereby speed up the bubble implosion process, whatever that process is. This can be achieved either by starting with a smaller dimensioned liquid vessel (having a corresponding higher resonance frequency) or by operating the pressure transducers at frequencies above the fundamental frequency of the vessel, at a harmonic frequency.

Generating Multiple Simultaneously Stationary in Space SL Bubbles

Operating at harmonic frequencies has the advantage of introducing a plurality of antinodes. This would be advantageous, because the more antinodes and the more closely they are spaced to one another the higher would be the density of SL bubble implosion induced fusion. That is, each anti node may be able to support a SL bubble. Accordingly, higher harmonic operation should provide a higher fusion yield per SL bubble and a greater density of SL bubbles.

If SL bubble generation requires a spherical antinode, then the cavity must have sufficient spherical symmetry. However, a large number of generally spherical but interconnected liquid chambers may provide the degree of spherical symmetry required. Alternatively, rectangular and other three dimensional geometry chambers in which antinodes compress from all sides to a point may be sufficient, and such chambers will have a plurality of such antinodes for higher harmonics of their base resonances.

Increasing Energy Gain Per Collision

One of my core assumptions is that achieving MEV energy photons requires multiple elastic collisions of the nuclei that remain in “the bubble.” However, elastic collisions between like weight nuclei results in a split in energy between the nuclei in the bubble that is propelled back into the bubble and the nuclei near the wall of the bubble that is propelled away from the bubble. Less energy is transferred to the nuclei propelled away from the bubble if it is relatively heavy compared to the nuclei propelled into the bubble. Accordingly, energy transfer to nuclei into the bubble may be increased by increasing the nuclear weight and therefore also cross section of elements in the liquid. For example, if a SL bubble containing D can be achieved in (high nuclear number) liquid mercury(operating at a temperature low enough that the Hg vapor pressure is not significant), it should result in a greater fraction of the D reaching MEV energies and therefore fusing.

Avoiding Inertial Resistance to Bubble Contraction

Moreover, SL bubble pressure should remain relatively low prior to and during implosion should to avoid inertial effects preventing bubble collapse to the point required to produce MEV kinetic energy nuclei. Accordingly, the liquid should have a relatively low vapor pressure at the temperature of operation, and the partial pressure of for example dissolved D2 should be low enough to avoid a too high density bubble. This generally requires using a liquid with a very high boiling point which also contains sufficient D (D2 or other molecular form) in solution sustain the SL bubbles.

Initiating Bubbles Versus Maintaining SL Bubbles

It should be noted here that I believe sustaining the SL bubbles is not equivalent to generating the SL bubbles. Initial bubble generation may not occur in for example heavy oil because that liquid may remain a liquid even at zero pressure, therefore forming no bubble. However, if seeded with an SL bubble whether or not producing fusion (for example a bubble containing D2 molecules) the existence of the bubble may be self sustaining. This is because the bubble implosion, whether or not it produces fusion, generates temperatures upon compression capable of breaking down molecular bonds and generating gas, and that gas will be in or near the bubble during the bubble expansion and in fact the positive gas pressure will assist in the bubble expansion. This process of bubble self sustainment should be more pronounced in fact when fusion occurs.

Interpretation of LLNL Data

The LLNL measurements detected a longer duration fluorescence in a large volume on the order of 10 microns or tens of microns in diameter. This fluorescence I understand to relate to nuclei, most certainly the vast majority of the nuclei initially in the bubble at its largest diameter, that at some point during the contraction of the bubble “leak out.” That is, they have collided with nuclei at a location on the order of ten or tens of microns from the center of the bubble and were not bounced back into the bubble as a result of that collision. As the bubble contracts, the nuclei remaining in the bubble increase in kinetic energy because they are bounced back toward the center by the ever increasing velocity collisions will atoms in the imploding bubble wall. The distribution of fluorescence intensity from the center of the bubble should reflect the cross section of nuclei as a function of their kinetic energy in the bubble over the cycle of bubble contraction and expansion. Thus, the LLNL data would indicate diffuse fluorescence over a period of time approaching one half the bubble size oscillation period due to hot nuclei that pass out of the bubble. The LLNL observed fast light pulse at the bubble center, it probably results from rapid thermalization and photon emission relating to the fusion reaction. As to the fast light pulse, it may be that there are very few nuclei remaining in the bubble at its nadir, and that these nuclei are close enough together to generate a novel many body interaction, with adjacent electrons that could explain the short duration of the, fast optical signal.

In any case, the choice of SL liquid to maximize fusion reactions should also account for two other factors. The first is the increased nuclear cross section with increasing nuclear mass and charge. Thus, again, heavier elements in the liquid should favor increased fusion efficiency. The second is the cross section for inelastic collisions, which relates to the electronic structure of the molecules or atoms in the liquid medium. Molecules that have lots of electronic levels would be more likely to be excited by collision with a hot nuclei propagating away from the bubble than molecules with less electronic levels. Of course, all atoms have a continuum of unbound electronic levels. However, it is likely that the lowest energy electronic levels are the most important because, as nuclei in the bubble begin to heat up due to collisions, there are more nuclei in the bubble then and later. At this point, a high loss in energy due to lots of inelastic collisions due to the relatively high density of gas in the bubble with liquid molecules loses relatively more energy in the bubble than later collisions when the remaining bubble gas and nuclei are already much hotter. Therefore atoms and molecules with no low lying electronic states are preferable for the liquid medium, such as carbon tetra chloride or other strongly bound ionic compounds that form high melting point low vapor pressure liquids. Perhaps fluorinated and chlorinated multi carbon atom or silicon compounds. Addition of a high concentration of heavy noble gas, such as Argon, partial pressure to the liquid, would be beneficial for this purpose.

Impulsion Ignition Theory

The foregoing analysis has omitted one factor, perhaps a crucial factor, which is the following. What happens to the energy of excited atoms that escape from the collapsing bubble? As the particles in the bubble gain kinetic energy to the point where they are more likely to penetrate out of the bubble instead of being scattered by the bubble wall, they begin to dump energy into the liquid immediately surrounding the bubble; within a few microns of the bubble. This liquid heats and expands. The expansion of the liquid around the bubble, particularly any transition of the liquid to a gaseous state, increases the centripetal force driving the particles where the bubble used to be inward. This acceleration of the bubble compression has positive feed back by driving up the kinetic energy of the nuclei remaining in the bubble region. In turn, many of those nuclei dump their energy into the region just outside the now smaller bubble. Thus, it may be the positive feedback of bubble compression due to heating of liquid just exterior the bubble that drives a catastrophic acceleration of the bubble collapse resulting in concentration of energy in a relatively few nuclei near the center of spherical symmetry that results in MEV energy levels. If in fact this positive feedback mechanism exists, it should be replicable by a very rapid heating of the bubble contents by other than acoustic pressure wave driven compression, as discussed further herein below. I call this positive feedback mechanism implosion ignition.

Pressure Wave Driven SL Induced Fusion Reactor

In a functioning thermonuclear energy source using pressure wave driven SL to induce fusion, the liquid medium would preferably be circulated with replacement liquid to achieve a steady state concentration of the composition of the liquid and partial pressure of Deuterium or similar fusion fuel, and to provide for heat transfer from that liquid to provide for capture of energy via conventional turbine electrical generator operation.

Process Changes That May Increase Fusion Yield in SL Driven Fusion

In sum, increased fusion yield via pressure wave driven SL to induce fusion may be mor readily achievable by:
(1) increasing resonant frequency,
(2) using a harmonic or cavity structure including multiple antinodes, preferably spherically symmetric,
(3) including heaving nuclei in the liquid medium,
(4) forming the liquid medium with materials having few low lying electron energy states,
(5) forming the liquid medium from a material having low partial pressure and low vapor pressure at the operating liquid temperature, and
(6) including D in some form such as D2 or D2O in solution or partial pressure in the liquid.
   Implosion Ignition

I now turn to the implosion ignition theory that positive feedback of the bubble compression due to heating of liquid just exterior the bubble is what drives a catastrophic acceleration of the collapse resulting in concentration of MEV scale energy a relatively few nuclei near the center of where the bubble used to be. Such a nonlinear mechanism would explain how very low energy density pressure waves could result in MEV level kinetic energy particles. That is, the inward acceleration caused by the initially acoustically induced pressure waves, result in sufficient kinetic energy in enough of the atoms and nuclei in the bubble that those particles are likely to traverse into the liquid some distance before losing all of their energy, and only a small fraction of the atoms and nuclei originating from the bubble collide at or close enough to the surface of the bubble to be bounced back towards the center of the bubble region. In this theory, as the material just outside the surface of the bubble increases in temperature, that increase in temperature causes an increase in pressure and rate of expansion of that material toward the center of the bubble, which both accelerates the atoms and molecules closer to the bubble surface towards the center and also increases the amount of energy imparted to each one of the relatively few ions and nuclei originating in the bubble that scatter off imploding matter back towards the center. This can be a positive feedback process if the increasing average kinetic energy of the particles that remain in the center increases the energy that the majority of those particle promptly dump into the imploding matter near the interface of what originally was a bubble surface.

The positive feedback process just described leading to bubble implosion is initiated in SBSL by the compression of the SBSL bubble induced by an acoustically generated pressure antinode. However, the theorized implosion ignition bubble compressive process is self generating once it passes a critical point, which I call the compression ignition point.

If compression ignition exists, then it should be able to be caused by any means other than SBSL, which provide the same ignition conditions provided by SBSL. Specifically, compression ignition should be causable by any mechanism that provides (1) either sufficient heating of the liquid adjacent the bubble surface or (2) both sufficient heating of the liquid adjacent the bubble surface at the same time the bubble surface is contracting. Thus, any, mechanism that rapidly and substantially enough heats the contents of the bubble to generate energetic particle that traverse the bubble interface and deposit their energy in the immediately surrounding liquid sufficient to cause the pressure in the matter surrounding the bubble to expand and therefore cause the bubble to contract fast enough and far enough to reach compressive ignition should suffice.

One means of heating of the liquid adjacent the bubble surface may be by heating the contents of an SL sized bubble with a laser beam (at a laser frequency highly absorbed by the bubble's contents and to which the liquid medium is transparent) to thereby result in sufficient heating and expansion of the liquid adjacent the bubble to cause bubble contraction. One way to accomplish this in conjunction with a D fuel in the bubble is to transmit a short, high energy laser pulse at a Balmer line of D2. For example via use of a pulsed dye laser tuned to generate about 4100 Angstrom wavelength. However, only a relatively small almost negligible amount of D2 is in an excitable Balmer ground state. Accordingly, it may be more useful to include an alternative or second gas, such as Deuterated or hydrogenated methane, CD4 or CH4 or the like hydrocarbon gas, which will optically absorb in the infrared or visible or UV spectrum. More toxic and more highly absorbing gases, such as bromine, chlorine, and sulfides, may be used. Preferably, the gas used includes relatively light elements, such as a hydrocarbon, as opposed to gasses including Chlorine, to limit the mass in the bubble, to limit the bubble's inertia against contraction.

Alternatively, the bubble may be surrounded by a relatively small shell of colored or otherwise laser pulse absorptive liquid and a laser pulse directed at the surrounding liquid to be absorbed by that liquid substantially uniformly around the bubble to initiate spherically uniform pressure on the bubble leading to bubble contraction sufficient to reach compressive ignition. For example, a colored liquid drop could be enclosed in a transparent gel, and bubble could be inserted into the liquid drop, via a needle. The drop could then be targeted with a suitable laser pulse. By relatively small volume of liquid, I mean a volume of liquid small enough so that, for example, the laser energy absorbed therein is sufficient to convert that volume of liquid at ambient pressure from a liquid to a gaseous state.

Alternatively, a laser pulse may be directed to a liquid (containing a bubble), the liquid having a relatively low absorption coefficient for the wavelength of the laser pulse, and the liquid having a volume compared to the energy absorbed by the laser pulse that would not result in conversion of the liquid to a gaseous state at room pressure. However, the liquid has a positive coefficient of thermal expansion, and the substantially instantaneous heating of the liquid substantially instantaneously generates a spherically symmetric centripetally directed pressure on the bubble.

In either of the laser heating of the liquid methods just described, a spherically symmetric centripetally directed pressure on the bubble is induced quite similar to the pressure that leads to SBSL. Accordingly, either mechanism should result in the same phenomena occurring during SBSL.

In addition, a relatively low power laser pulse focused to a point in a liquid can vaporize liquid, resulting in a bubble. Thus, a bubble may in this manner be controllably generated inside of a liquid. A bubble may also be generated by expulsion of gas from a needle inserted into a bubble, and such a bubble may be shaken lose from the needle by for example vibrating or jerking the needle, or sending a small jet or pulse of liquid at the tip of the needle expelling the gas. A bubble formed by either mechanism may be transported to a desired location by providing laminar flow in the surrounding liquid.

The benefits of using a laser to induce compressive ignition in a bubble are numerous. For example, the bubble's contents can be prepared and ignition timed as desired, in contrast to SBSL where bubble and reaction periodicity are defined by an antinode location defined by a resonance condition and at a resonance frequency. For example, using laser induced ignition, a sequence of bubbles could be launched into a laminar flow stream and a laser pulse timed to intercept each bubble (or a volume of liquid surrounding the bubble) as the bubble passes a certain location, thereby repeating the implosion ignition process in the same region of space at a frequency defined by the user (by controlling liquid flow velocity and bubble insertion or creation rate), instead of by acoustic resonance relating to a container. Moreover, such a process would enable parallel substantially simultaneous ignition of pluralities of such bubbles, enable control of bubble and liquid composition and flow rate in a manner suitable for high rate of bubble implosions and heat transfer to a secondary medium of a power generating system.

By relying upon laser induced heating of a liquid, the amount of heating and therefore induced pressure in the liquid, may be controlled by suitably dying the liquid with material highly absorptive to the wavelength of laser radiation in the laser pulse. For example, rhodamine G dye may be used to dye H2O to a degree desired when using a dy laser generating a laser pulse using the same Rhodamine G dye as the active media. Alternatively, NaCl may be used as the dopant to H2O when using an excimer laser of the type which is transparent in H2O but which is absorbed by the presence of NaCl in H2O, such as 193 or 248 nm excimer lasers.

One example of a laser induced bubble fusion generator would include a flow system including a bubble injection sub system including a needle, a source of gas connected to the needle, and flow control for the gas designed to provide a determined rate and size and composition of bubbles, a transparent liquid flowing in a laminar fashion at a high rate of speed past an optically transparent region whereat a laser was timed to generate a relatively intense and relatively short laser pulse that was focused to the surround the current location of a bubble in the laminar stream of liquid. Alternatively, bubbles may be created at point in a liquid by focusing a relatively less intense laser pulse at that point, such as a 0.01 or 0.001 or 0.0001 joule laser pulse of suitable wavelength.

One of a laser useful for heating the liquid to initiate bubble contraction would be a 10 nsec duration 1 joule 193, 248, or 308 nanometer excimer laser pulse, or 1 micron wavelength Nd—YAG laser pulse. The liquid container would have to include an optical window of material suitable for the laser wavelength allowing the laser pulse entry to the chamber. Preferably, the volume of liquid in the path of this laser pulse is less than 100 milliliters, preferably less than 50 milliliters, in order to generate sufficient heat, and therefore sufficient pressure uniformly around the bubble for compression ignition.

Since laser induced pressure driven compression ignition does not rely upon standing waves in the liquid, there is no requirement on liquid chamber geometry. For example, the chamber in which the laser induced pressure driven compression occurs may be a long cylindrical or rectangular conduit instead of a structure having spherical symmetry.

Preferred liquids include carbon tetrachloride, ethylene glycol, water, any carbon based oil. However, any liquid, including conventional hydrocarbon liquids, may suffice.

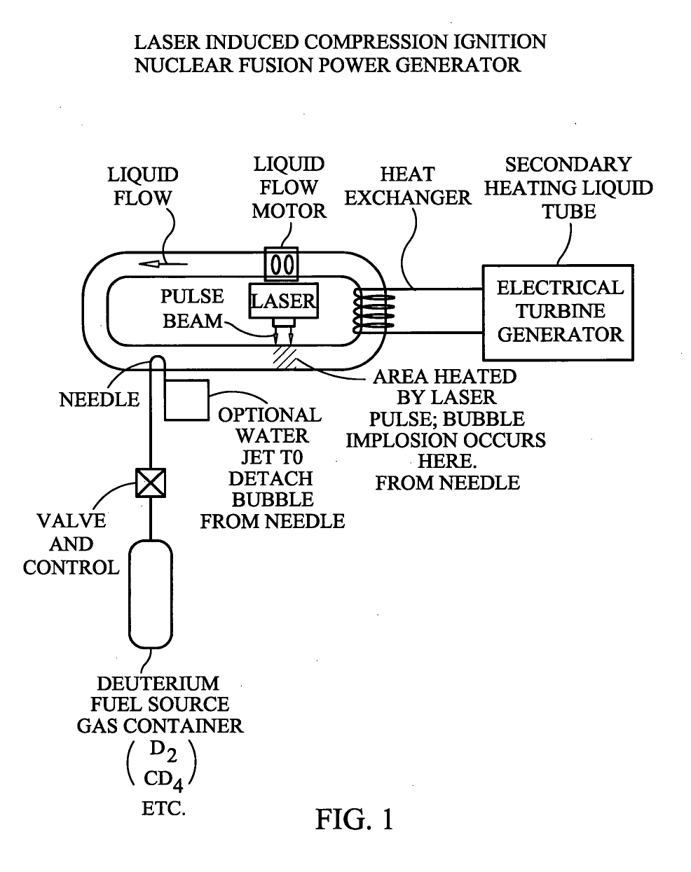

FIG. 1 shows a schematic of aspects of a laser induced compression ignition nuclear fusion power generator. FIG. 1 shows a closed loop circulating liquid first flow path. A source of bubbles containing nuclear fusion fuel, such as Deuterium, connect to the first flow path. a laser is positioned to provide to the liquid a powerful laser pulse downstream of where the bubble is created and timed to traverse a volume including the location of the bubble. A second flow path of a second liquid is coupled to enable heat transfer from the first flow path to the second flow path, and the second flow path is coupled to a convention turbine or the like electrical power generator.

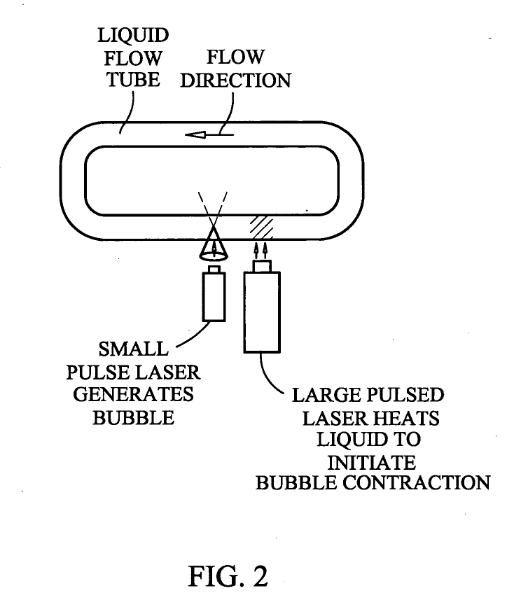

FIG. 2 shows an optional first flow path in which the bubble is created by focusing to a point a laser pulse from a second laser. In this embodiment, Deuterium or like nuclear fusion fuel (tritium, helium, etc) exists (either dissolved or in a molecular form) in the liquid, and as a result the bubble created by the laser pulse contains substantial nuclear fuel.

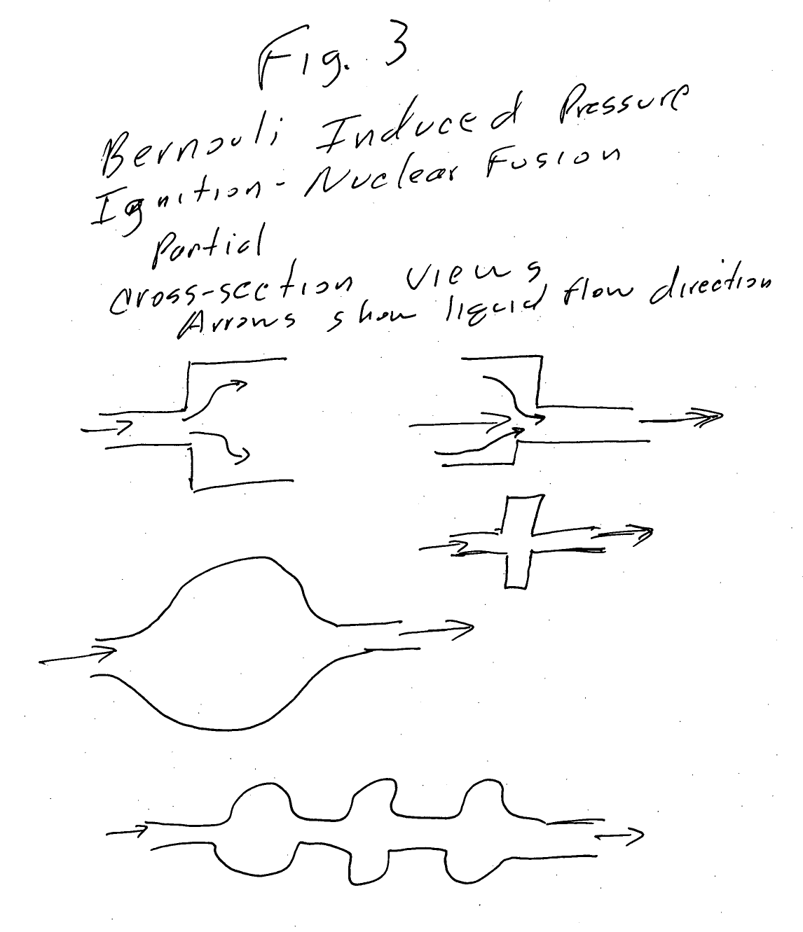

FIG. 3 shows a flow path in which pressure change is induced via Bernouli's law by changing the flow cross-section. In this embodiment, fluid flow induced pressure change subsitutes for the laser pulse induced pressure change of the previous embodiments. A benefit of this embodiment is that it is less complicated, and would operate without the need for a pulsed laser to generate the bubble implosions or bubble creation and implosions necessary for bubble induced nucelar fustion.

I claim:

1. A system for generating nuclear fusion comprising:
a conduit for enclosing a liquid;
a source of pressure to force said liquid to flow in said conduit;
a bubble generator designed to generate bubbles in said conduit; and
at least one of a pulsed laser positioned so that pulses of said pulsed laser impinge liquid in said conduit and a variation in cross-section of said conduit designed to induce rapid pressure changes in liquid flowing in said conduit; and
wherein said system is designed such that operation results in flow of liquid in the conduit and nuclear fusion of nuclei of atoms in said liquid.

2. The system of claim 1 wherein said system comprises said pulsed laser.

3. The system of claim 1 wherein said system comprises said variation in cross-section of said conduit.

4. The system of claim 1 wherein said source of pressure includes an impeller.

5. The system of claim 1 wherein said liquid comprises at least one of Deuterium and Tritium at a concentration higher than concentrations occurring in nature.

6. The system of claim 5 wherein said concentration is at least 0.1 atomic percent of hydrogen atoms.

7. The system of claim 6 wherein said concentration is at least 10 atomic percent of hydrogen atoms.

8. A method for generating nuclear fusion comprising:
providing a conduit for enclosing a liquid;
providing a source of pressure to force said liquid to flow in said conduit;
providing a bubble generator designed to generate bubbles in said conduit; and
providing at least one of a pulsed laser positioned so that pulses of said pulsed laser impinge liquid in said conduit and a variation in cross-section of said conduit designed to induce rapid pressure changes in liquid flowing in said conduit; and
flowing liquid in said conduit to generate nuclear fusion of nuclei of atoms in said liquid.
